(19) United States
(12) Patent Application Publication
(10) Pub. No.: US 2013/0284732 A1
(43) Pub. Date: Oct. 31, 2013

(54) VEHICLE TANK AND/OR FILL PIPE FOR SUCH A TANK

(71) Applicant: Jules-Joseph Van Schaftingen, Wavre (BE)

(72) Inventor: Jules-Joseph Van Schaftingen, Wavre (BE)

(73) Assignee: Inergy Automotive Systems Research (Societe Anonyme), Bruxelles (BE)

(21) Appl. No.: 13/880,833

(22) PCT Filed: Oct. 20, 2011
(86) PCT No.: PCT/EP2011/068299

§ 371 Date: Jul. 15, 2013

(30) Foreign Application Priority Data
Oct. 22, 2010 (FR) 1058637

(51) Int. Cl. B60K 15/04; B60K 15/01

(52) U.S. Cl. CPC B60K 15/04; B60K 15/013
USPC 220/4.14; 220/86.2; 264/523

(57) ABSTRACT

A vehicle tank and/or fill pipe for the vehicle tank, the vehicle tank and/or the fill pipe including a flexible part having an auxetic structure and/or a flexible part including helicoidal corrugations.

The present invention relates to a vehicle tank and/or a fill pipe for such a tank.

Fuel tanks and additive tanks for motor vehicles (land vehicles in the frame of the invention) are increasingly being based on plastics particularly because they are lighter in weight (by comparison with their metal counterparts) and easier to mould complex shapes. Traditionally, plastic tanks are made by extrusion/blow-moulding. This process generates an envelope through which openings are made to accommodate the various functionalities, including the filling system.

This filling system generally comprises:

a filler cap for plugging it,

a filling head, and

a fill pipe.

The latter is generally made either of metal or of plastic. It is preferably, like the tank, made of plastic and one of its ends is intended to be fastened to the tank (to an opening in this tank, or to a neck provided for this purpose) by a welding operation or by a simple mechanical connection, for example by a quick connect, or by means of a sleeve and 2 clamping collars, etc., its other end generally being intended to be fastened to the chassis of the vehicle (and in particular, in the case of fuel tanks, to the filling bowl located below the fuel tank flap).

In certain cases, the first operation (fastening of the pipe to the tank) is carried out by the tank manufacturer and the assembly is fastened to the vehicle by the manufacturer of the latter. In order to facilitate the latter operation, taking into account the accepted dimensional tolerances from one vehicle to the next and the vibrations and deformations observed during the lifetime of the vehicle, it is known to provide the fill pipe with a flexible part that may or may not be made from one piece with it.

Thus, it is known to use a smooth or corrugated rubber connection between the two parts, but such a solution is expensive and increases the risk of leaks.

It is also known to use a pipe having a corrugated part (i.e. provided with transverse and generally circular annular corrugations) made as one piece with it. Such a pipe is for example described in document WO 2001/68397. Indeed, this type of structure/pipe makes it possible to partly solve the aformentioned problems.

However, the fact of having increased flexibility both in the axes transverse to the pipe but also longitudinally along the axial direction of the pipe and also in torsion would make it possible to obtain gains/advantages which no one has contemplated to date, namely:
the fact of limiting stresses in the event of an impact (accident) and therefore, of limiting the damage to the fuel system in this case;
the fact of being able to render the tank/pipe assembly more compact (by deformation of this pipe) and therefore, of limiting the logistics costs linked to the transport from the tank manufacturer to the motor vehicle manufacturer;
the fact of being able to mould the pipe from one piece with the tank and of being able, after demoulding and removal of possible scrap, to change the relative position of the pipe with respect to the tank so as to limit the logistics costs as mentioned above and so as to be able, in a second step, to fit the assembly to the vehicle in the functional position;
the possibility of adapting one and the same pipe model to various vehicle models.

It should be noted that similar advantages may be obtained by imparting a similar degree of flexibility to at least one part of the tank, this variant also having the advantage of being able to avoid the use of foams, seals or other absorbing elements at the points of contact between the tank and the vehicle chassis.

The invention hence relates to a vehicle tank and/or fill pipe for this tank, comprising a flexible part having an auxetic structure. A tank/fill pipe having a flexible part provided with helicoidal corrugations could show similar advantages but the variant with an auxetic structure is particularly attractive in terms of flexibility and is more easily applicable to the tank than the variant with helicoidal corrugations.

The term “tank” is understood to mean a leaktight chamber intended for the storage of fuel, of an additive (a fuel additive (such as those required for reducing the combustion temperature of the particles retained on the particulate filters of diesel engines for example), an exhaust gas additive (such as urea or other precursors of ammonia in SCR (Selective Catalytic Reduction or NOx reduction) systems, etc.)) or of any other fluid onboard a land (terrestrial) vehicle (car, lorry, etc.).

The expression “fill pipe” is understood to mean a pipe which communicates the outside with the inside of the tank and allows fluid to be introduced into it.

According to the invention, the tank and the pipe are made of a material that is compatible with each of the fluids that they are likely to handle. In the case of fuel tanks, this material must be chemically inert both with respect to volatile liquid hydrocarbons and heavy liquid hydrocarbons at the customary operating pressures and temperatures. It may be a plastic or a metal. It should be noted that the tank and the pipe may be made of mixed materials, i.e. may comprise metal parts and plastic parts.

Thermoplastics give good results within the context of the invention, especially due to the advantages of weight, mechanical strength and chemical resistance and easier processing.

In particular, it is possible to use polyolefins, polyvinyl halides, thermoplastic polyesters, polyketones (such as POM or polyoxymethylene for example), polyamides and copolymers thereof. A blend of polymers or copolymers may also be used; similarly it is also possible to use a blend of polymer materials with inorganic, organic and/or natural fillers such as, for example but non-limitingly: carbon, salts and other inorganic derivatives, natural fibres, glass fibres or polymer fibres. It is also possible to use multilayer structures consisting of stacked layers bonded together, comprising at least one of the polymers or copolymers described above.

Polyvinyl halides and polyolefins are generally preferred. One polymer often employed is polyethylene. Excellent results have been obtained with high-density polyethylene (HDPE). In a known manner, the impermeability of this plastic to volatile hydrocarbons may be improved by surface treatment (fluorination, sulphonation, etc.) and/or by the use of a barrier layer (for example based on polyamide (PA) or on a polyvinyl alcohol [homopolymer (PVOH) or ethylene/vinyl alcohol copolymer (EVOH)].

Preferably, the tank and the fill pipe according to the invention are multilayer structures that include at least one layer based on HDPE and at least one layer based on EVOH (the expression “based on” meaning “mainly composed of”, it being understood that these layers may comprise other polymers and/or additives in a minor amount (by weight)). It should be noted that tanks and pipes having at least one layer of polyamide are also suitable for the present invention.

According to the invention, the tank and/or the pipe comprise a flexible part having an auxetic structure and optionally, a flexible part provided with helicoidal corrugations.

The term “part” is understood to mean both a piece added on to the tank and/or to the pipe, and an integral portion of these, the latter variant being preferred however.

The expression “flexible part” is understood in fact to mean that the part in question is more flexible than the rest of the tank and/or of the pipe and that this flexibility is acquired in various spatial directions. For example, it has been verified that the torsional stiffness of a thin-walled pipe is reduced by 50% by adopting a helicoidal cross section instead of a cylindrical part at the bottom of the pipe.

The expression “auxetic structure” is understood to mean a structure having a negative apparent Poisson's ratio, i.e. that when it is stretched in one direction (vertical direction for example), it is also subjected to stretching in the perpendicular direction (horizontal direction in the example).

The terms “part having an auxetic structure” designate in fact a part made of a material which is not auxetic per se (by nature) but which has been processed (shaped) in a way such that its structure (i.e. shape, geometry) renders it auxetic.

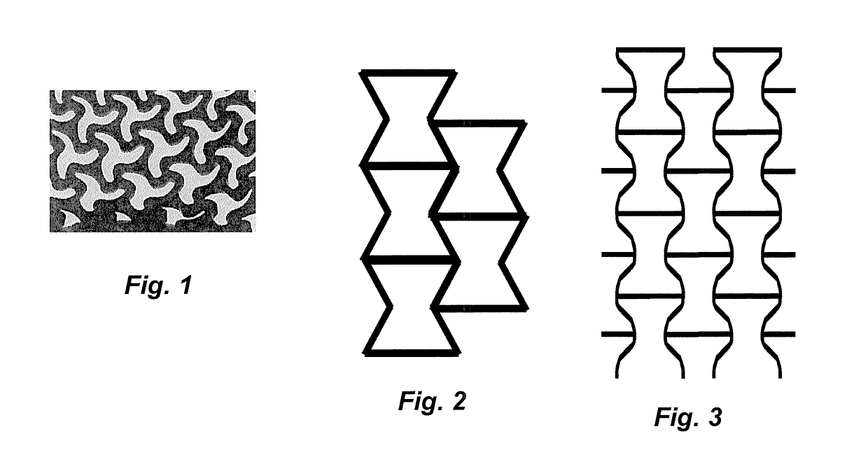

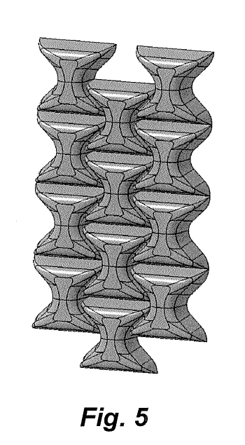

Given that the tank and the pipe must be leaktight, this structure is preferably free of orifices. It is preferably a three-dimensional (3D) structure obtained by moulding the inner and/or outer surface of one part of the tank and/or of the pipe. Such a 3D auxetic structure (an example of which is shown in FIG. 5 attached) can be obtained from a two-dimensional auxetic structure comprising elementary cells of the same shape and being rendered leaktight by addition of surfaces (for instance of of pyramidal shape) connecting the various points of the elementary cells. It is possible, for example, to have an auxetic structure on a reference (2D) surface, and to plug the openings therein by connections in one or more other planes. Various two-dimensional auxetic structures are known, such as for example triangular structures (see appended FIG. 1), trapezoidal structures (see appended FIG. 2) or sinusoidal structures (see appended FIG. 3). These structures may be rendered leaktight by addition of a surface of pyramidal shape connecting the various points of an elementary cell constituting the auxetic two-dimensional base. These pyramids may be of various heights, and may be oriented both towards the inside and towards the outside of the component. Materials having auxetic characteristics may also be used, in combination or not with the structures described above.

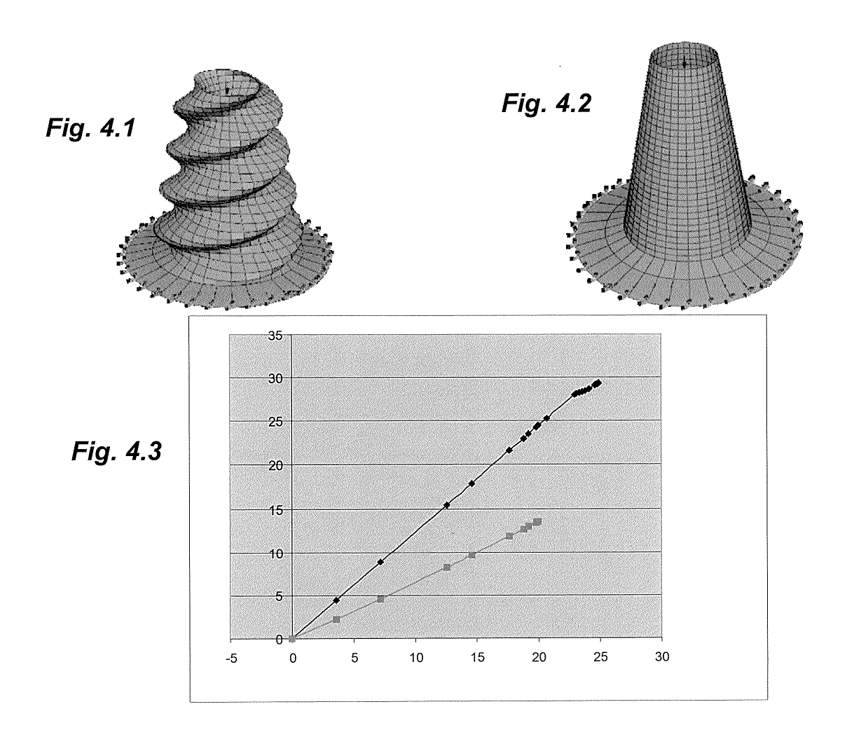

The expression “helicoidal corrugations” is understood in fact to mean a single groove having the shape of a helix and that therefore in a way provides corrugations (indented reliefs) that are oblique and are not perpendicular to the axis of the article (which matches that of the helix). It should be noted that the helix may be a multiple helix (in particular a double helix: see appended FIG. 4.1). The flexible part may also comprise at least one cross section where the helix goes round in the clockwise direction and a cross section where the helix goes round in the anti-clockwise direction, which has the advantage of inhibiting the rotation of the article when it is compressed or elongated in the direction of its axis (axis of the helix).

The variant with helicoidal corrugations is easier to apply to the pipe than to the tank. A pipe having a flexible part with corrugations (whatever their shape: circular, helicoidal . . . ) is always advantageous within the frame of the invention, since it adds flexibility to the tank/pipe structure.

According to one advantageous variant of the invention, the cross section of the pipe is divergent in order to reduce pressure drops.

A finite element simulation (Abaqus) was carried out respectively on a divergent double-helical structure (see appended FIG. 4.1) and on a divergent cone (see appended FIG. 4.2) of equivalent dimensions, both having a thickness of 0.35 mm and both being based on HDPE. The result of the simulation (moment (in Nm) as a function of the angle of deformation (in degrees) obtained during torsion of the pipe) is set out in appended FIG. 4.3. A reduction in the stiffness of around 40% is observed on going from the cone (lozenges) to the double-helical structure (squares).

In a preferred embodiment, the present invention relates to a fuel tank comprising a flexible part having an auxetic structure located in its zone of connection with the fill pipe.

An advantageous combination is that where a pipe bottom with helicoidal corrugations (and which is preferably flared) is connected to the part of the tank having an auxetic structure.

The present invention also relates to a vehicle equipped with a tank and/or with a pipe as described above, and where the auxetic structure is located at a point of contact between the tank and the vehicle and/or at a point which may be subjected to impact and/or at a point which, due to its nature or due to the method of manufacture, could be embrittled, such as for example the vicinity of a joint line, the vicinity of a weld or the vicinity of a metallic insert.

The present invention also relates to a process for manufacturing a tank and/or a pipe as described above, according to which an auxetic part was obtained by moulding the wall of the tank and/or the pipe. One advantageous way consists in producing the shapes necessary for the auxetic structure within the blow-moulding mould, so that the blow-moulded piece directly comprises this structure.

The part comprising helicoidal corrugations may be obtained by blow moulding a parison; it may also be obtained by gradual deformation of a smooth tubular part of the tank and/or of the pipe through a die having a suitable internal relief, such as for example described in patent U.S. Pat. No. 3,824,826, the content of which is, for this purpose, incorporated by reference in the present application. Finally, it may be obtained by blow moulding and/or compression moulding, by inserting inside the parison a finger comprising the helicoid, the mould then being closed over the parison containing the finger and thus ensuring a compression moulding at the helicoid. The finger is then released from the piece by rotation and withdrawal.

When the tank and the pipe are made of the same material, it is sometimes advantageous to blow mould the tank and the pipe in one and the same mould. This is already the case today for certain commercial tanks/pipes. However, these are not interconnected during the blow moulding (the pipe is placed about ten centimetres below the tank), and the 2 pieces are assembled on the finishing line. One variant of the invention would consist in blow moulding the 2 pieces that are already functionally attached (therefore with the pipe opening into the tank) with an inclination of the pipe relative to the tank that is suitable for the constraints of blow moulding, and after removal of the scrap, adjusting the position of the pipe (which is made possible thanks to the increased flexibility) as required during finishing, transport and/or mounting onto the vehicle.

1-15. (canceled)

16. A vehicle tank and/or fill pipe for the tank, the vehicle tank and/or the fill pipe comprising:
a flexible part having an auxetic structure.

17. A tank and/or pipe according to claim 16, made of plastic.

18. A tank and/or pipe according to claim 17, based on a multilayer structure that includes at least one layer based on HDPE and at least one layer based on EVOH, and/or comprising at least one layer based on polyamide.

19. A tank and/or pipe according to claim 16, further comprising a flexible part having a three-dimensional (3D) auxetic structure obtained by blow molding.

20. A tank and/or pipe according to claim 19, wherein the 3D auxetic structure is obtained from a two-dimensional auxetic structure comprising elementary cells of a same shape and being rendered leaktight by addition of surfaces of pyramidal shape connecting various points of the elementary cells.

21. A tank and/or pipe according to claim 20, wherein the elementary cells are triangular, trapezoidal, or sinusoidal.

22. A tank and/or pipe according to claim 16, further comprising a flexible part having double-helical corrugations.

23. A tank and/or pipe according to claim 16, further comprising a flexible part having a cross section with helical corrugations that go round in the clockwise direction and a cross section with helical corrugations that go round in the anti-clockwise direction.

24. A fill pipe according to claim 16, further comprising a flexible part with corrugations.

25. A fill pipe according to claim 16, having a divergent cross section.

26. A tank according to claim 16, further comprising a flexible part having an auxetic structure located in its zone of connection with the fill pipe.

27. A tank according to claim 26, further comprising a fill pipe bottom, or a flared fill pipe bottom, with helicoidal corrugations connected to the part of the tank having an auxetic structure.

28. A vehicle comprising a tank and/or with a pipe according to claim 16, in which the auxetic structure is located at a point of contact between the tank and the vehicle and/or at a point that may be subjected to impact and/or at a point which, due to its nature or due to a method of manufacture, could be embrittled.

29. A process for manufacturing a vehicle tank and/or a fill pipe for the vehicle tank comprising a flexible part having an auxetic structure, according to which the auxetic part is obtained by blow molding.

30. A process according to claim 24, according to which the blow molding of the vehicle tank and of the fill pipe is carried out in one and a same mold and according to which the vehicle tank and the fill pipe are directly attached in the one and the same mold.
